(19) United States
(12) Patent Application Publication
(10) Pub. No.: US 2014/0344619 A1
(43) Pub. Date: Nov. 20, 2014

(54) PROCESSOR CAPABLE OF DETECTING FAULT AND METHOD OF DETECTING FAULT OF PROCESSOR CORE USING THE SAME

(71) Applicant: ELECTRONICS AND TELECOMMUNICATIONS RESEARCH INSTITUTE, Daejeon-city (KR)

(72) Inventor: Young-Su KWON, Daejeon (KR)

(73) Assignee: ELECTRONICS AND TELECOMMUNICATIONS RESEARCH INSTITUTE, Daejeon-city (KR)

(21) Appl. No.: 14/208,415

(22) Filed: Mar. 13, 2014

(30) Foreign Application Priority Data
May 14, 2013 (KR) 10-2013-0054098

(51) Int. Cl. G06F 11/16; G06F 9/30

(52) U.S. Cl. CPC G06F 11/1641; G06F 9/30145
USPC 714/11

(57) ABSTRACT

A processor capable of detecting fault and a method of detecting the fault of processor core using the same are disclosed. The processor includes a first processor core, a second processor core, and a fault manager. The first processor core includes one or more pipeline registers. The second processor core has a same structure as the first processor core, and is included in a single chip along with the first processor core. The comparator compares the value of the pipeline register of the first processor core with the value of the pipeline register of the second processor core. The fault manager performs a fault management operation if, as a result of the comparison of the comparator, it is determined that a fault has occurred.

### CROSS REFERENCE TO RELATED APPLICATION

This application claims the benefit of Korean Patent Application No. 10-2013-0054098, filed on May 14, 2013, which is hereby incorporated by reference in its entirety into this application.

### BACKGROUND OF THE INVENTION

1. Technical Field

The present invention relates generally to a microprocessor and, more particularly, to a processor that is capable of detecting a fault using pipeline registers, and a method of detecting the fault of a processor core using the processor.

2. Description of the Related Art

Processor cores are hardware or semiconductor intellectual property (IP) that read instructions stored in a storage device, such as memory or a disk, perform specific operations on operands in accordance with operations encoded in the instructions, and store the results of the operations in the storage device, thereby executing an algorithm for a specific application.

Processors are widely applied to almost all the fields of system semiconductors. The application of processors has extended to a variety of fields including: the field of high-performance media data processing for large amounts of multimedia data, such as the compression and decompression of video data, the compression and decompression of audio data, the manipulation of audio data, and the processing of sound effects; the field of minimum-performance microcontroller platforms, such as modems for wired and wireless communication, voice codec algorithms, platforms for the processing of network data, touch screens, controllers for household appliances, platforms for the control of motors; and the field of devices to which power cannot be stably supplied or external power cannot be supplied, such as wireless sensor networks, and ultra-small electronic devices.

A processor basically includes a core, a translation lookaside buffer (TLB), and a cache. A task that will be performed by a processor is defined as a combination of a plurality of instructions. That is, instructions are stored in memory. When the instructions are sequentially input to the processor, the processor performs a specific operation in each clock cycle. The TLB functions to translate virtual addresses into physical addresses in order to run an application based on an operating system. The cache functions to increase the speed of the processor by temporarily storing instructions, stored in external memory, in a chip.

Recently, in the field of automobile systems, driver assistance systems, such as an advanced driver assistance system (ADAS), which have high intelligence and high precision, have been actively developed, and the importance of electronic systems has continuously increased.

In particular, it is expected that as a need for devices for detecting an environment outside a vehicle is increasing, the number of applications that utilize processor cores having a performance of 500 MHz or higher than an existing performance in the range of 50 MHz to 100 MHz will considerably increase. Such applications include motion detection for a smart black box, pedestrian recognition during the running of a vehicle, the recognition of a driver's driving pattern or drowsy driving, lane detection and driving assistance, etc.

In order to detect an external environment, analyze detected image and/or voice and/or sensor input, and directly or indirectly intervene in the driving of an automobile, the functionality of analyzing a large amount of data in real time using a high-performance processor core and extracting results, such as the detection of a pedestrian, is required. In particular, lane detection-based driving assistance applications may directly influence a steering apparatus based on the results of detection. Methods of directly influencing a steering apparatus for an automobile may include a method of applying vibration to a steering wheel or limiting the rotation angle of a steering wheel in order to notify a driver of the results of lane detection.

The reliability of a processor core is very important to applications that may directly influence a steering apparatus for an automobile. That is, if a processor core is erroneously operated because of a factor, such as voltage, current, temperature, or the like, and thus a steering apparatus for an automobile is incorrectly controlled, a driver's life may be influenced, with the result that the reliability of the processor core should be absolutely guaranteed.

That is, it is very important to high-performance processor cores to guarantee the reliability of the processor cores.

U.S. Pat. No. 7,206,966 discloses technology in which two cores are implemented in a microcontroller, a program required by an application is executed on a first core, and diagnostic code is executed on a second core. However, this technology is problematic in that the operation thereof is complicated because context switching should be performed between the two cores, etc.

Accordingly, there is an impending need for a new processor core that is capable of efficiently guaranteeing its reliability.

### SUMMARY OF THE INVENTION

Accordingly, the present invention has been made keeping in mind the above problems occurring in the conventional art, and an object of the present invention is to, when a fault has occurred in a processor core because of a factor, such as voltage, current, temperature or the like, simply and efficiently detect the occurrence of the fault.

Another object of the present invention is to rapidly determine the point of time at which a fault has occurred in a processor core and the cause of the fault.

In accordance with an aspect of the present invention, there is provided a processor, including a first processor core configured to include one or more pipeline registers; a second processor core configured to have a same structure as the first processor core, and to be included in a single chip along with the first processor core; a comparator configured to compare a value of a pipeline register of the first processor core with a value of a pipeline register of the second processor core; and a fault manager configured to, if, as a result of the comparison of the comparator, it is determined that a fault has occurred, perform a fault management operation.

Each of the first and second processor cores may include an instruction fetch unit configured to generate a fetched instruction by fetching a read instruction; a branch predictor configured to perform branch prediction using the fetched instruction; an instruction queue configured to store an instruction based on results of the branch prediction; an instruction decoder configured to decode the instruction stored in the instruction queue; and an execution unit configured to execute the decoded instruction.

The pipeline registers may include an instruction fetch unit register configured to store a result of the instruction fetch unit, and to provide an input of the branch predictor; a branch prediction register configured to store a result of the branch predictor, and to provide an input of the instruction queue; an instruction queue register configured to store a result of the instruction queue, and to provide an input of the instruction decoder; and an instruction decoder register configured to store a result of the instruction decoder, and to provide an input of the execution unit.

The comparator may compare the value of the pipeline register of the first processor core with the value of the pipeline register of the second processor core in every clock cycle, and may report the occurrence of a fault to the fault manager if it is determined that a fault has occurred.

The comparator may determine whether the fault has occurred by comparing a value of the instruction fetch unit register of the first processor core with a value of the instruction fetch unit register of the second processor core; comparing a value of the branch prediction register of the first processor core with a value of the branch prediction register of the second processor core; comparing a value of the instruction queue register of the first processor core with a value of the instruction queue register of the second processor core; and comparing a value of the instruction decoder register of the first processor core with a value of the instruction decoder register of the second processor core.

The fault manager may reset the first and second processor cores if it is determined that a fault has occurred.

The fault manager may notify a system of occurrence of a fault and also terminate a current operation if it is determined that a fault has occurred.

The fault manager may switch to fault mode using read only memory (ROM) if it is determined that it is determined that a fault has occurred.

In accordance with another aspect of the present invention, there is provided a method of detecting the fault of a processor core, including reading the value of the pipeline register of a first processor core that includes one or more pipeline registers; reading the value of the pipeline register of a second processor core that has a same structure as the first processor core and is included in a single chip along with the first processor core; comparing the value of the pipeline register of the first processor core with the value of the pipeline register of the second processor core; and performing a fault management operation depending on results of the comparison.

The comparing may include comparing the value of the pipeline register of the first processor core with the value of the pipeline register of the second processor core in every clock cycle.

The comparing may include determining whether a fault has occurred by comparing a value of the instruction fetch unit register of the first processor core with a value of the instruction fetch unit register of the second processor core; comparing a value of the branch prediction register of the first processor core with a value of the branch prediction register of the second processor core; comparing a value of the instruction queue register of the first processor core with a value of the instruction queue register of the second processor core; and comparing a value of the instruction decoder register of the first processor core with a value of the instruction decoder register of the second processor core.

The performing a fault management operation may include resetting the first and second processor cores if it is determined that a fault has occurred.

The performing a fault management operation may include notifying a system of occurrence of a fault and also terminating a current operation if it is determined that a fault has occurred.

The performing a fault management operation may include switching to fault mode using ROM if it is determined that a fault has occurred.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a processor according to an embodiment of the present invention;

FIG. 2 is a block diagram illustrating an example of each of the first and second processor cores illustrated in FIG. 1; and

FIG. 3 is an operation flowchart of a method of detecting the fault of a processor core according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Embodiments of the present invention will be described in detail with reference to the accompanying drawings.

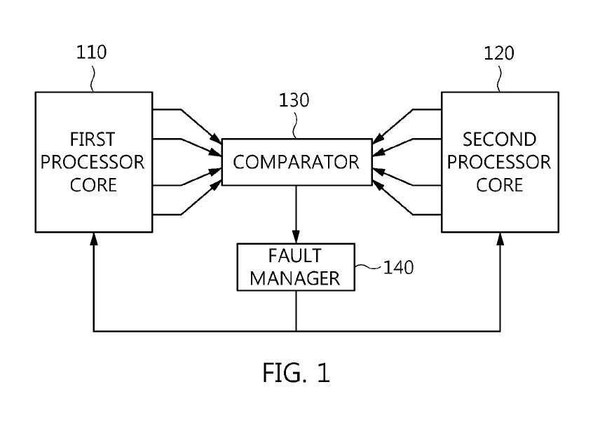

FIG. 1 is a block diagram of a processor according to an embodiment of the present invention.

Referring to FIG. 1, the processor according to this embodiment of the present invention includes a first processor core 110, a second processor core 120, a comparator 130, and a fault manager 140.

The first and second processor cores 110 and 120 are hardware that read respective instructions and perform an operation of the processor.

Each of the first and second processor cores 110 and 120 includes one or more pipeline registers.

In this case, the second processor core 120 has the same structure as the first processor core 110, and is included in a single chip along with the first processor core 110.

In this case, each of the first and second processor cores 110 and 120 includes a plurality of hardware units including an instruction fetch unit configured to fetch a read instruction and generate the fetched instruction; a branch predictor configured to predict a branch using the fetched instruction; an instruction queue configured to store an instruction based on the results of the branch prediction; an instruction decoder configured to decode the instruction stored in the instruction queue; and an execution unit configured to execute the decoded instruction.

In this case, a plurality of pipeline registers may be present between the hardware units that constitute each of the first and second processor cores 110 and 120. That is, the pipeline registers may include an instruction fetch unit register configured to store the results of the instruction fetch unit and provide the input of the branch predictor; a branch prediction register configured to store the results of the branch predictor and provide the input of the instruction queue; an instruction queue register configured to store the results of the branch predictor and provide the input of the instruction decoder; and an instruction decoder register configured to store the results of the instruction decoder and provide the input of the execution unit.

The comparator 130 compares the value of the pipeline register of the first processor core 110 with the value of the pipeline register of the second processor core 120. That is, the comparator 130 corresponds to a pipeline comparator that compares the values of the registers that are present between the pipelines of the first and second processor cores 110 and 120.

In this case, the comparator 130 may compare the value of the pipeline register of the first processor core 110 with the value of the pipeline register of the second processor core 120 in every clock cycle, and may report the occurrence of a fault to the fault manager 140 if it is determined that a fault has occurred.

In this case, the comparator 130 may determine whether a fault has occurred by comparing the value of the instruction fetch unit register of the first processor core 110 with the value of the instruction fetch unit register of the second processor core 120, comparing the value of the branch prediction register of the first processor core 110 with the value of the branch prediction register of the second processor core 120, comparing the value of the instruction queue register of the first processor core 110 with the value of the instruction queue register of the second processor core 120, and comparing the value of the instruction decoder register of the first processor core 110 with the value of the instruction decoder register of the second processor core 120.

If, as a result of the comparison of the comparator 130, it is determined that a fault has occurred, the fault manager 140 performs a fault management operation.

If it is determined that a fault has occurred, the fault manager 140 may switch to operation mode for the occurrence of a fault by resetting the first and second processor cores 110 and 120.

If it is determined that a fault has occurred, the fault manager 140 may notify an external system of the occurrence of the fault, and may terminate an operation.

If it is determined that a fault has occurred, the fault manager 140 may switch to read only memory (ROM) using a fault mode.

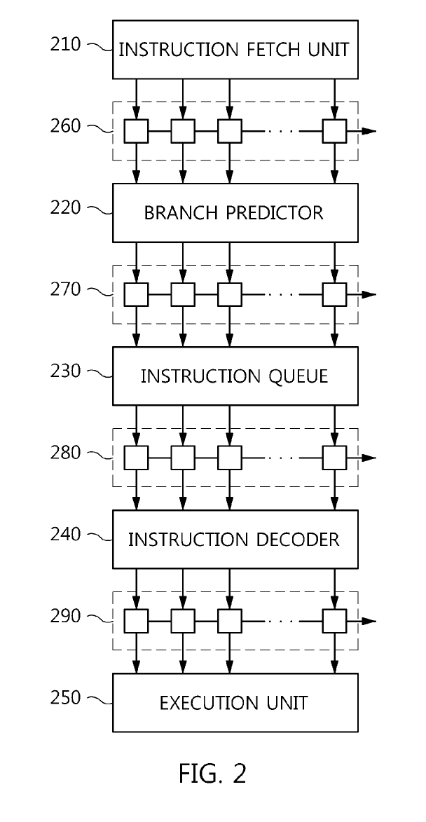

FIG. 2 is a block diagram illustrating an example of each of the first and second processor cores illustrated in FIG. 1.

That is, the second processor core illustrated in FIG. 1 has the same structure as the first processor core, and is implemented in a chip along with the first processor core.

Referring to FIG. 2, each of the first and second processor cores illustrated in FIG. 1 includes an instruction fetch unit 210, a branch predictor 220, an instruction queue 230, an instruction decoder 240, an execution unit 250, an instruction fetch unit register 260, a branch predictor register 270, an instruction queue register 280, and an instruction decoder register 290.

The instruction fetch unit 210 generates a fetched instruction by fetching a read instruction.

The branch predictor 220 performs branch prediction using the fetched instruction.

The instruction queue 230 stores the instruction based on the results of the branch prediction.

The instruction decoder 240 decodes the instruction stored in the instruction queue 230.

The execution unit 250 executes the decoded instruction.

The instruction fetch unit register 260 stores the results of the instruction fetch unit 210, and provides the input of the branch predictor 220.

The branch prediction register 270 stores the results of the branch predictor 220, and provides the input of the instruction queue 230.

The instruction queue register 280 stores the results of the instruction queue 230, and provides the input of the instruction decoder 240.

The instruction decoder register 290 stores the results of the instruction decoder 240, and provides the input of the execution unit 250.

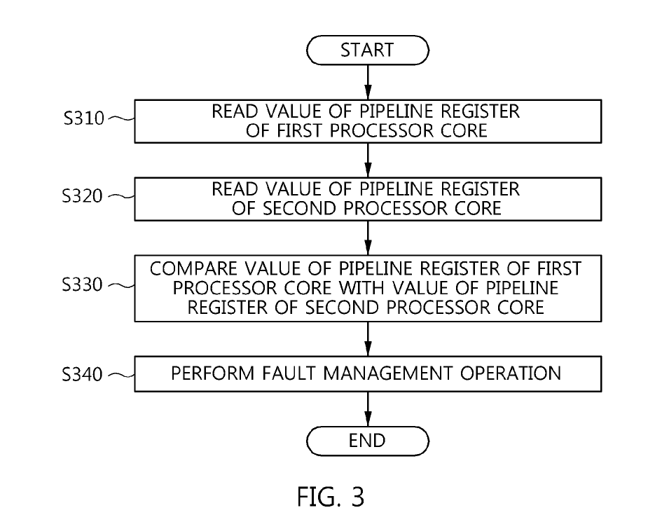

FIG. 3 is an operation flowchart of a method of detecting the fault of a processor core according to an embodiment of the present invention.

Referring to FIG. 3, in the method of detecting the fault of a processor core according to this embodiment of the present invention, the value of the pipeline register of a first processor core including one or more pipeline registers is read at step S310.

Furthermore, the value of the pipeline register of a second processor core that has the same structure as the first processor core and is implemented in a single chip along with the first processor core is read at step S320.

Furthermore, the value of the pipeline register of the first processor core is compared with the value of the pipeline register of the second processor core at step S330.

Furthermore, a fault management operation is performed based on the results of the comparison at step S340.

At step S330, the value of the pipeline register of the first processor core may be compared with the value of the pipeline register of the second processor core in every clock cycle.

At step S330, whether a fault has occurred may be determined by comparing the value of the instruction fetch unit register of the first processor core with the value of the instruction fetch unit register of the second processor core, comparing the value of the branch prediction register of the first processor core with the value of the branch prediction register of the second processor core, comparing the value of the instruction queue register of the first processor core with the value of the instruction queue register of the second processor core, and comparing the value of the instruction decoder register of the first processor core with the value of the instruction decoder register of the second processor core.

At step S340, if it is determined that the fault has occurred, the first and second processor cores may be reset.

At step S340, if it is determined that the fault has occurred, the occurrence of the fault may be reported to the system, and an operation may be terminated.

At step S340, if it is determined that the fault has occurred, switching to fault mode may be performed using the ROM.

When a circuit fault that is not intended by the designer of a processor core occurs in a specific part of a circuit inside the first processor core (or second processor core) because of a change in voltage, current, temperature or the like, a difference occurs between the value of the pipeline register of the first processor core and the value of the pipeline register of the second processor core in a corresponding cycle.

The occurrence of a fault in the processor cores may be detected by comparing the value of the pipeline register of the first processor core with the value of the pipeline register of the second processor core in every clock cycle. Based on the detection of the occurrence of a fault, the processor cores may be reset, or the occurrence of the fault may be reported to the outside.

In accordance with the present invention, when a fault has occurred in a processor core because of a factor, such as voltage, current, temperature, or the like, the occurrence of the fault may be simply and efficiently detected only by comparing the values of the pipeline registers of two processor cores.

Furthermore, in accordance with the present invention, the point of time at which a fault has occurred in a processor core may be rapidly determined by comparing the values of the pipeline registers of two processor cores in every cycle, and a stage in which a fault has occurred may be determined by comparing the values of pipeline registers in each stage inside the processor cores, thereby rapidly identifying the cause of the fault.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A processor, comprising:
a first processor core configured to include one or more pipeline registers;
a second processor core configured to have a same structure as the first processor core, and to be included in a single chip along with the first processor core;
a comparator configured to compare a value of a pipeline register of the first processor core with a value of a pipeline register of the second processor core; and
a fault manager configured to, if, as a result of the comparison of the comparator, it is determined that a fault has occurred, perform a fault management operation.

2. The processor of claim 1, wherein each of the first and second processor cores comprises:
an instruction fetch unit configured to generate a fetched instruction by fetching a read instruction;
a branch predictor configured to perform branch prediction using the fetched instruction;
an instruction queue configured to store an instruction based on results of the branch prediction;
an instruction decoder configured to decode the instruction stored in the instruction queue; and
an execution unit configured to execute the decoded instruction.

3. The processor of claim 2, wherein the pipeline registers comprise:
an instruction fetch unit register configured to store a result of the instruction fetch unit, and to provide an input of the branch predictor;
a branch prediction register configured to store a result of the branch predictor, and to provide an input of the instruction queue;
an instruction queue register configured to store a result of the instruction queue, and to provide an input of the instruction decoder; and
an instruction decoder register configured to store a result of the instruction decoder, and to provide an input of the execution unit.

4. The processor of claim 3, wherein the comparator compares the value of the pipeline register of the first processor core with the value of the pipeline register of the second processor core in every clock cycle, and reports occurrence of a fault to the fault manager if it is determined that a fault has occurred.

5. The processor of claim 4, wherein the comparator determines whether the fault has occurred by:
comparing a value of the instruction fetch unit register of the first processor core with a value of the instruction fetch unit register of the second processor core;
comparing a value of the branch prediction register of the first processor core with a value of the branch prediction register of the second processor core;
comparing a value of the instruction queue register of the first processor core with a value of the instruction queue register of the second processor core; and
comparing a value of the instruction decoder register of the first processor core with a value of the instruction decoder register of the second processor core.

6. The processor of claim 5, wherein the fault manager resets the first and second processor cores if it is determined that a fault has occurred.

7. The processor of claim 6, wherein the fault manager notifies a system of occurrence of the fault and also terminates a current operation if it is determined that a fault has occurred.

8. The processor of claim 6, wherein the fault manager switches to fault mode using read only memory (ROM) if it is determined that a fault has occurred.

9. A method of detecting a fault of a processor core, comprising:
reading a value of a pipeline register of a first processor core that includes one or more pipeline registers;
reading a value of a pipeline register of a second processor core that has a same structure as the first processor core and is included in a single chip along with the first processor core;
comparing the value of the pipeline register of the first processor core with the value of the pipeline register of the second processor core; and
performing a fault management operation depending on results of the comparison.

10. The method of claim 9, wherein the comparing comprises comparing the value of the pipeline register of the first processor core with the value of the pipeline register of the second processor core in every clock cycle.

11. The method of claim 10, wherein the comparing comprises determining whether a fault has occurred by:
comparing a value of the instruction fetch unit register of the first processor core with a value of the instruction fetch unit register of the second processor core;
comparing a value of the branch prediction register of the first processor core with a value of the branch prediction register of the second processor core;
comparing a value of the instruction queue register of the first processor core with a value of the instruction queue register of the second processor core; and
comparing a value of the instruction decoder register of the first processor core with a value of the instruction decoder register of the second processor core.

12. The method of claim 11, wherein the performing a fault management operation comprises resetting the first and second processor cores if it is determined that a fault has occurred.

13. The method of claim 12, wherein the performing a fault management operation comprises notifying a system of occurrence of a fault and also terminating a current operation if it is determined that a fault has occurred.

14. The method of claim 12, wherein the performing a fault management operation comprises switching to fault mode using ROM if it is determined that a fault has occurred.
